(19) United States
(12) Patent Application Publication
(10) Pub. No.: US 2006/0072667 A1
(43) Pub. Date: Apr. 6, 2006

(54) Transcoder for a variable length coded data stream

(75) Inventors: Ihor Kirenko, Eindhoven (NL); Gerben Johan Hekstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/535,284

(22) PCT Filed: Oct. 29, 2003
(86) PCT No.: PCT/IB03/04885

§ 371 Date: May 17, 2005

(30) Foreign Application Priority Data
Nov. 22, 2002 (EP) 02079947.4

(51) Int. Cl. H04N 11/04; H04N 7/12; H04B 1/66; H04N 11/02

(52) U.S. Cl. 375/240.23; 375/240.03; 375/240.2; 375/240.08

(57) ABSTRACT

The invention relates to a transcoder (100) for a variable length coded data stream such as an MPEG 2 coded data stream transcoder (100) comprises a receiver (101) which receives the variable length coded data stream. The receiver (101) is connected to a significance processor (107) that determines if a variable length coded coefficient is significant or less significant. The significance processor (107) is connected to a truncation processor (111) which truncates the less significant coefficients. The trancoder further comprises an encode processor (109) which generates a transcoded data stream from the original significant coefficients and the truncated less significant coefficients. All processing may be performed exclusively in the variable length code domain thereby providing a low complexity and high speed transcoder.

### FIELD OF THE INVENTION

The invention relates to a transcoder and a method of transcoding for a variable length coded data stream and in particular for transcoding of a compressed video data stream.

### BACKGROUND OF THE INVENTION

Video signals are increasingly being broadcast and distributed as digital video signals. In order to maintain low data rates, various forms of video compression are normally used. Consequently, a number of different video compressions standards have been defined. A widely used compression standard is the MPEG-2 (Moving Picture Expert Group-2) standard which is used in for example terrestrial and satellite digital TV broadcasting, DVDs and digital video recorders.

The MPEG-2 video standard comprises a number of different levels and profiles allowing for different data rates and the complexity of encoders and decoders to be traded off against the video quality.

During the transmission of a compressed video stream from a source to end terminals, it is frequently necessary to adjust the bit rate of the compressed stream according to the current capacity of the channel or capabilities of the decoder. Such bit-reducing operations are typically performed by a transcoder which comprises a cascade of the operations of decoding and an encoding. The decoding part completely reconstructs a video stream and feeds it to an encoder that generates the new stream with a lower bit rate.

Generally, independent decoding and encoding of an MPEG stream may lead to degradation of video quality. Decisions taken during the re-encoding do not take into account the parameters of the original encoding. Moreover, although some elements may be shared between an encoder and decoder, a cascaded implementation is complex and expensive as both a full decoder and encoder functionality needs to be implemented.

Additionally, transcoders have been developed wherein the received video signal is decoded to the pixel domain or a Discrete Cosine Transform (DCT) domain. The compression parameters are then modified in this domain and the signal is re-encoded. However, this approach is still computational intensive. Furthermore, the effect on the transcoded bit rate from operations in the pixel or DCT domain cannot easily be determined or controlled.

In recent years, the popularity of multimedia networks has grown rapidly. Typically, these networks, among other things, transmit video information in compressed streams. In most cases, multimedia networks are heterogeneous comprising different types of wired or wireless channels and sets of decoders with different capabilities. In the case of wireless networks, the wireless communication channel typically provides extremely low guaranteed minimum Quality of Service levels. Consequently, the variation of the channel bandwidth and quality is typically spurious and unpredictable. Additionally, the range of different capabilities and requirements of decoders may be very large. Accordingly, a compressed stream should preferably be able to quickly adapt its bit-rate to the current channel bandwidth. Additionally, changes in the channel characteristics should not result in unacceptable degradation of video quality.

Therefore, in order to transmit one compressed video stream to decoders having different functionality, capabilities and requirements, scalable coded video streams are sometimes used. The scalability allows the decoder to take a portion of the video stream and decode a full picture therefrom. Thus the scalability allows the decoder to take a portion of the transmitted stream and decode the picture with reduced quality or resolution. The quality level of the decompressed image depends on how much of the video stream is used by the decoder, and on how the scalable compressed stream is organised.

Generally, scalability is useful when interaction between the encoder and decoder is limited or absent such as one-to-many communication, non real-time applications, etc. In the current video coding standards like MPEG-2 or MPEG-4, scalability is implemented through a layered structure, where encoded video information is divided into two or more bitstreams corresponding to the different layers. The more layers that are received, the better quality or higher resolution could be achieved during decoding. Specifically a base layer is provided that comprises sufficient information to regenerate a video signal albeit at low quality. In addition, one or more enhancement layers are provided comprising additional information that may be used to increase the decoded video quality.

Hence, it is desirable to provide scalable streams and specifically a transcoder, which is able to provide a scalable stream is advantageous. Current transcoders capable of providing a scalable stream from a non-scalable stream are typically implemented by cascading a full non-scalable decoder and a full scalable encoder. Unfortunately, such an approach is complex, expensive and cannot provide fast and flexible adaptation of the bit-rate.

Hence, current transcoders tend to be suboptimal and in particular complex, expensive to implement, inflexible, have high delays, have limited data rate capability and adaptability and are resource demanding. Hence, an improved system for transcoding would be advantageous.

### SUMMARY OF THE INVENTION

Accordingly, the Invention seeks to mitigate, alleviate or eliminate one or more of the above mentioned disadvantages singly or in any combination.

According to a first aspect of the invention, there is provided a transcoder for a variable length coded data stream comprising: a receiver for receiving the variable length coded data stream comprising variable length coded coefficients; a significance processor for determining if variable length coded coefficients are significant coefficients or less significant coefficients in accordance with a significance criterion; a truncation processor for truncating the less significant coefficients; an encode processor for generating a transcoded data stream comprising significant coefficients and truncated less significant coefficients.

The transcoded data stream may thus be provided based on operations and determinations performed in the variable length code domain, and specifically, the transcoded data stream may be generated based only on operations performed in the variable length code domain. The operations and determinations may be performed directly on the variable length coded data stream, and the transcoder may generate a transcoded data stream without performing any domain transformations or (inverse) quantisation adjustments. This allows for a very low complexity and cost of the transcoder. Specifically, memory space and memory bandwidth requirements may be very low allowing for a simple transcoder.

In addition, the processing in the variable length code domain allows for a fast transcoding therefore making the transcoder suitable for higher bit rate data streams. Also, delay incurred by the transcoding may be kept low or reduced. Furthermore, the transcoder may be enabled to perform a transcoding without having specific information of other coding schemes than the variable length code used. Specifically, if a transcoder has information of the variable length protocol of the variable length code, the same transcoder may transcode differently encoded signals, such as for example signals encoded by different compression schemes. This may allow for a single (uniform) bit-rate control mechanism independent on the compression standard

Additionally, the invention may allow for an improved quality of the transcoded data stream as any quality degradation associated with processing steps not in the variable length code domain can be avoided.

The transcoder is particularly suitable for transcoding a higher bit rate data stream to a lower bit rate data stream. Preferably, the variable length coded data stream is a compressed digital video signal stream. Hence, a very fast and/or low complexity transcoding may be achieved for video signals compressed in accordance with a widespread video compression scheme. The transcoding requires no de-quantisation or re-quantisation, nor any inverse or forward Discrete Cosine Transformation. It therefore allows for reduced complexity, increased speed and/or improved video quality.

Furthermore, a very direct and thus precise control of the data stream is enabled as the transcoded data stream for example may be achieved directly by bit manipulation of the variable length coded data stream. Hence, the effect on the variable length code words of the transcoded data stream is directly known. In contrast to conventional transcoding schemes, the characteristics of the transcoded data stream may be directly known and affected, and thus for example a bit rate reduction may be directly managed by control of the data bits of the transcoded data stream.

The receiver, significance processor, truncation processor and encode processor may be separate functional units or may be different aspects or functionality of the same functional unit or process. Specifically, the receiver, significance processor, truncation processor and encode processor may be implemented as a software programme in a single suitable data processor, such as a Digital Signal Processor. The truncation of the less significant coefficients may specifically be achieved by a shifting operation.

According to a feature of the invention, the truncation comprises setting a value of the less significant coefficients to zero. Preferably, the truncation of less significant coefficients is to zero value coefficients, which typically have the lowest word length in variable length codes. Alternatively or additionally, zero coefficients are particularly suited for run length coding thereby allowing for the possibility of a significant data rate reduction of the transcoded signal.

According to a feature of the invention, the significance criterion comprises a criterion of whether a value of a variable length coded coefficient is above a threshold. Specifically, a variable length encoded coefficient may be considered significant if it has a value (such as a level in an MPEG-2 coded data stream) above the threshold, and less significant if it has a value below the threshold. The truncation may thus only be performed for a variable length coded coefficient if the value of the coefficient is below a threshold. Truncation of only less significant coefficients may improve the quality of the transcoded signal as only information for less significant coefficients is discarded. A threshold value provides a suitable and low complexity means for determining the significance of a coefficient and the degree of bit rate reduction of the transcoding.

According to a feature of the invention, the significance criterion is determined in response to an associated frequency parameter of a signal encoded by the variable length coded stream.

In most signals, the quality degradation incurred by loss of information is higher when it relates to some frequency ranges than other. For example, video degradation is more sensitive to low spatial frequency coefficient errors. Truncating coefficients dependent on an associated frequency parameter of the coefficients therefore provide for increased quality of the decoded signal. Specifically, for an MPEG-2 compressed video signal, the significance criterion may be different depending on the spatial frequency associated with a coefficient. For example, lower frequency coefficients may be considered significant and higher frequency coefficients may be considered less significant. The significance criterion for a coefficient may thus depend on where in the Discrete Cosine Transformation block it is located.

According to a feature of the invention, the variable length coded coefficients are run length coded. Run length coding may provide for a very efficient coding of data streams comprising a high number of zero coefficients and are therefore particularly suitable for the truncation performed in the transcoding.

According to a feature of the invention, the significance criterion comprises a criterion of whether a run length of a sequence of variable length coded coefficients is above a threshold. Many signals, such as for example an MPEG 2 encoded video signal, tend to have increasing concentration of zero coefficients in sections of relatively lower quality significance. A significance criterion taking into account the number of zero coefficients proximal to a non-zero coefficient thus provides an advantageous significance criterion for many signals. The sequence may specifically comprise a single variable length coded coefficient.

According to a feature of the invention, a run length value of a significant coefficient is modified to reflect increased zero coefficients resulting from truncation of less significant coefficients to a zero value.

Preferably, the run length value of a significant coefficient is modified to reflect an increased number of preceding zero coefficients resulting from truncation of less significant coefficients to a zero value. A very efficient transcoding of an encoded data stream may be achieved simply by including information on the number of truncated less significant coefficients in the run length information of the significant coefficients.

According to a feature of the invention, the transcoder further comprises a subset processor for providing a subset of the variable length coded data stream to the encode processor; and wherein the encode processor is operable to directly include the subset of the variable length coded data stream in the transcoded data stream.

Preferably, some data of the variable length coded data stream are directly included in the transcoded data stream. This may allow for reduced complexity and increased speed of the transcoding as only a subset of the variable length coded data stream need to be processed. It may further ensure that some data having a high quality impact may be moved to the transcoded data stream unaffected by the transcoding.

According to a feature of the invention, the subset of the variable length coded data stream comprises variable length coded coefficients associated with low frequency parameters of a signal coded by the variable length coded stream.

For many signals, such as a compressed video signal, the quality sensitivity to data errors is higher for data associated with low frequencies than with higher frequencies. Hence, directly including variable length coded coefficients associated with low frequency parameters of the signal in the transcoded data stream allows for improved quality. It may further result in faster and/or lower complexity transcoding.

According to a feature of the invention, the subset of the variable length coded data stream comprises variable length coded coefficients associated with motion compensation parameters of a video signal coded by the variable length coded stream. Advantageously, any motion compensation parameters, including motion estimation parameters, may directly be included in the transcoded data stream.

According to a feature of the invention, the subset of the variable length coded data stream comprises control data. Advantageously, any control data of the variable length coded data stream may directly be included in the transcoded data stream.

According to a feature of the invention, the subset of the variable length coded data stream comprises header data. Advantageously, any header data of the variable length coded data stream may directly be included in the transcoded data stream thereby allowing for a transcoded data stream having a format consistent with the variable length coded data stream.

According to a feature of the invention, the truncation processor is further operable to perform a diminution operation on values of the significant coefficients. The diminution may preferably be of the coefficient values, such as the variable length code levels for an MPEG-2 compressed signal. The diminution operation may preferably result in a lower word length for at least some values of the significant coefficients.

According to a feature of the invention, the diminution operation is a shifting operation. Provided the shifting value is known at a receiver of the transcoded data stream, the original value may be regenerated without loss of information. The shifting operation may thus reduce the data rate of the transcoded data stream without a loss of information for the higher value coefficients.

According to a feature of the invention, the diminution operation depends on an associated frequency parameter of a signal encoded by the variable length coded stream.

The diminution operation may result in loss of information (or truncation) for low variable length code coefficient values, and the diminution operation is therefore preferably varied in response to the typical coefficient values or variation. Alternatively or additionally, the diminution operation may be varied in response to a quality impact of loss of information characteristic. These characteristics are typically related to the frequency associated with the variable length code coefficient on which the diminution operation is performed. Advantageously, the parameters of the diminution operation may thus be varied for different coefficients depending on an associated frequency parameter. Specifically, for an MPEG 2 encoded data stream, the diminution performed may depend on the coefficient's position in the Discrete Cosine Transformation block.

According to a feature of the invention, the diminution operation depends on a run length associated with at least one variable length coded coefficient. This may for example allow for diminution of spurious coefficients (located in the middle of long sequences of zeros) more, than coefficients within a significant zone (with small number of zeros).

According to a feature of the invention, a diminution operation parameter is depending on a plurality of coefficient values of the significant coefficients. Preferably, at least one parameter of the diminution operation, such as the shifting value of a shifting operation, is optimised for the coefficient values of at least a subset of the variable length coded data stream. Specifically, the parameters of a shifting operation may be selected such that a suitable data reduction is achieved by the shifting operation for the current distribution of coefficient values in the subset.

According to a feature of the invention, a diminution operation parameter depends on an achievable word length reduction for at least one of the significant coefficients. Preferably the diminution operation parameters are selected such as to achieve a word length reduction for as many significant coefficients as possible while still retaining a desired information level and thus quality level.

According to a feature of the invention, the encode processor is operable to generate a scalable signal data stream comprising the transcoded data stream as a base layer and at least one additional enhancement layer.

A transcoded scalable signal data stream may thus be provided comprising a base layer allowing for reduced quality signal to be derived. The signal may be further improved by including additional information of the at least one enhancement layer. Preferably, the transcoder thus generates a base layer from the transcoded data stream. The base layer may preferably provide a reduced but acceptable quality representation of the signal of the variable length coded data stream but at a reduced data rate. A decoder may generate an acceptable signal based only on the base layer (including the transcoded data stream) or may optionally utilise the additional information of the enhancement layer to improve the quality. This allows for the transcoder to be used with different types of decoders and distribution mediums with varying characteristics.

According to a feature of the invention, the truncation processor is operable to generate remainder coefficient values associated with the truncation of the less significant coefficients, and the at least one additional enhancement layer comprises at least some of the remainder coefficient values.

Preferably, the information lost by the truncation of the truncation processor is comprised in the remainder coefficients. The at least one additional enhancement layer thus preferably comprises the information lost during the truncation process. This allows for a decoder to optionally use the enhancement layer to counter the loss in quality of the transcoded data stream with respect to the variable length coded data stream.

According to a feature of the invention, the truncation processor is operable to perform a shifting operation on the significant coefficients and to generate remainder coefficient values associated with the shifting operation; and the at least one additional enhancement layer comprises at least some of the remainder coefficient values.

Preferably, the information lost by the shifting operation of the truncation processor is comprised in the remainder coefficients. The at least one additional enhancement layer thus preferably comprises the information lost during the shifting operation. This allows for a decoder to optionally use the enhancement layer to counter the loss in quality of the transcoded data stream with respect to the variable length coded data stream.

According to a feature of the invention, the truncation processor is further operable to perform a second shifting operation on the remainder coefficient values and to generate second remainder coefficient values, and the encoding processor is operable to include at least some of the second remainder coefficient values in a second enhancement layer.

Preferably, the remainder coefficient values are further divided into different levels by a shifting operation. Each further refinement of the information is included in an additional enhancement layer. This allows for an increased granularity in the available quality levels to a decoder.

According to a second aspect of the invention, there is provided an encoder for encoding a signal comprising: a signal encoder for generating a variable length coded data stream from the signal; the variable length coded data stream comprising variable length coded coefficients; a significance processor for determining if variable length coded coefficients are significant coefficients or less significant coefficients in accordance with a significance criterion; a truncation processor for truncating the less significant coefficients and for generating remainder coefficient values associated with the truncation of the less significant coefficients; and an encode processor for generating a scalable signal data stream comprising a base layer comprising significant coefficients and truncated less significant coefficients and an enhancement layer comprising at least some of the remainder coefficient values.

According to a third aspect of the invention, there is provided a decoder for decoding a scalable content signal data stream; the decoder comprising: a receiver for receiving the scalable content signal data stream; the scalable content signal data stream comprising a base layer comprising significant coefficients and truncated less significant coefficients, and an enhancement layer comprising remainder coefficient values associated with the truncated less significant coefficients; a combine processor for generating a combined data stream from combining the variable length coded coefficients and truncated less significant coefficients of the base layer and the remainder coefficient values of the enhancement layer; and a decode processor for generating a decoded signal in response to the combined data stream.

According to a fourth aspect of the invention, there is provided a decoder for decoding a variable length coded data stream; the decoder comprising: a receiver for receiving a variable length coded data stream comprising variable length coded coefficients having shifted coefficient values; and a shift processor for generating a shift compensated data stream by performing an inverse shifting operation on the variable length coded coefficients having shifted coefficient values; and a decode processor for generating a decoded signal in response to the shift compensated data stream.

According to a feature of the invention, the decoder further comprises a shift value receiver for receiving a shift value parameter associated with the shifted coefficient values and wherein the inverse shifting operation is determined in response to the shift value parameter.

According to a fifth aspect of the invention, there is provided a method of transcoding of a variable length coded data stream, the method comprising the steps of: receiving the variable length coded data stream comprising variable length coded coefficients; determining if variable length coded coefficients are significant coefficients or less significant coefficients in accordance with a significance criterion; truncating the less significant coefficients; and generating a transcoded data stream comprising significant coefficients and truncated less significant coefficients.

These and other aspects of the invention will be apparent from and elucidated with reference to the embodiment(s) described hereinafter.

### BRIEF DESCRIPTION OF THE DRAWINGS

An embodiment of the invention will be described, by way of example only, with reference to the drawings, in which

FIG. 1 is an illustration of a transcoder in accordance with an embodiment of the invention;

FIG. 2 is an illustration of an example of a shifting matrix for a shifting operation in accordance with an embodiment of the invention;

FIG. 3 is an illustration of a transcode processor for generating a scalable data stream in accordance with an embodiment of the invention.

### DESCRIPTION OF PREFERRED EMBODIMENTS

The following description focuses on an embodiment of the invention applicable to a transcoder for a variable length encoded video data stream and in particular to an MPEG 2 coded video data stream. However, it will be appreciated that the invention is not limited to this application but may be applied to many other applications and variable length coded data stream including for example audio or multimedia streams.

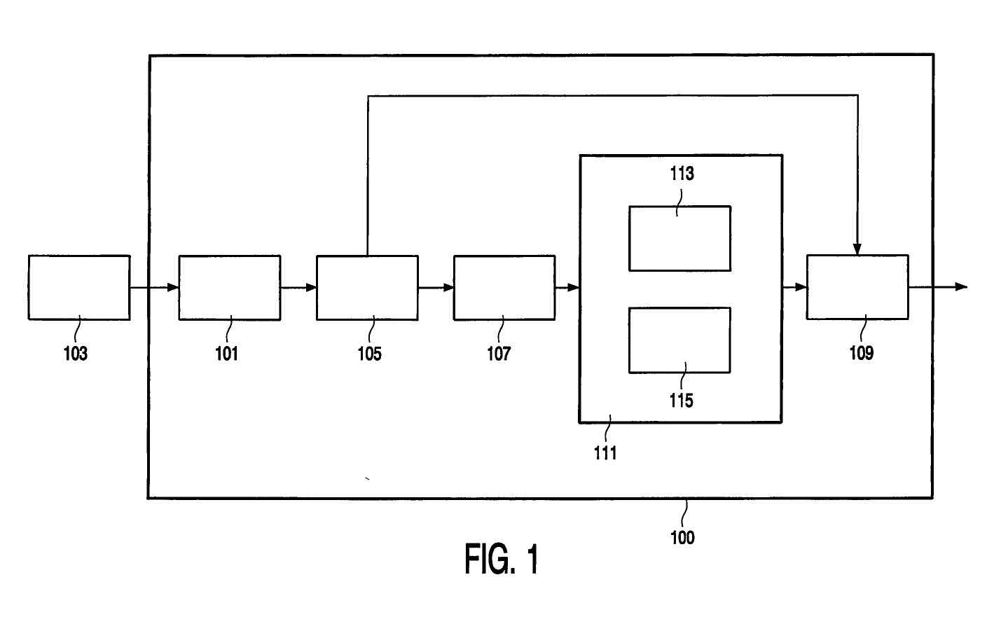

FIG. 1 is an illustration of a transcoder 100 in accordance with an embodiment of the invention.

The trancoder 100 comprises a receiver 101 which in the preferred embodiment receives an MPEG 2 encoded video signal from an external source 103.

The receiver 101 is connected to a subset processor 105. The received data stream is fed to the subset processor 105. The subset processor 105 analyses the received data stream and divides the data into picture data and control data. The control data comprises header information and other data not directly related to the images of the video signal. The subset processor is connected to a significance processor 107 and an encode processor 109, and in the preferred embodiment, the control data is fed directly to the encode processor 109 and the picture da is fed to the significance processor 107.

The significance processor 107 is thus fed a stream of variable length coded video data The significance processor analyses this data in the variable length code domain and divides the variable length coded coefficients into significant coefficients and less significant coefficients. Any suitable criteria or criterion may be used for determining if a variable length coded coefficient is significant or less significant but in the preferred embodiment, a coefficient is simply considered significant if it has a coefficient value above a certain threshold.

The significance processor 107 is connected to a truncation processor 111. The truncation processor 111 comprises a truncation element 113 to which the less significant coefficients are fed. The truncation element 113 performs a truncation operation on the less significant coefficients. The truncation may be any suitable operation but preferably reduces the number of bits required to represent the coefficient in the variable length code. As such, the truncation may be performed by directly truncating coefficients in response to a look-up table of corresponding non-truncated and truncated coefficient values. A truncation operation may optionally be performed by a shifting operation performed on a less significant coefficient, and specifically the less significant bits may be dropped by such an operation. Hence, preferably, the truncation operation achieves a bit reduction but may consequently result in loss of information.

In the preferred embodiment, the truncation is achieved by setting the value of all coefficients determined to be less significant coefficients to a zero value. In most variable length code schemes, the zero coefficient value requires the least number of bits to be represented. In addition, coding schemes, such as MPEG2, further comprises run length coding of the variable length code data thereby having a highly efficient representation of consecutive zero values. Accordingly, setting coefficient values to zero may lead to a very significant bit rate reduction.

In some embodiments, the truncation processor 111 does not perform any operations on the significant coefficients. However, in the preferred embodiment, the truncation processor 111 further comprises a diminution element 115, which performs a diminution operation on the significant coefficients. The diminution operation performs an arithmetic reduction on the significant coefficients and specifically performs a shifting operation on the coefficients. Specifically the shifting operation of a variable length code representation of a coefficient of sufficient value may lead to a bit rate reduction without a resultant loss of information, as the decoder may regenerate the original value by an inverse shifting operation.

The truncation processor 111 is connected to the encode processor 109, which is fed the truncated less significant coefficients and the (possibly diminuted) significant coefficients. In the preferred embodiment of an MPEG 2 signal further comprising run length coding, the run length values of the significant coefficients are modified to include the number of truncated zero coefficients of the less significant coefficients, and a data stream comprising both the significant and less significant coefficients are fed to the encode processor 109. The encode processor combines the control data, the significant coefficients and the truncated less significant coefficients into a transcoded data stream. In the preferred embodiment, the received MPEG2 signal is thus regenerated but with the less significant coefficients replaced by zero coefficients. Accordingly, a bit rate reduction of the original data stream has been achieved. Hence, the reduction in the bit rate of the data stream may be achieved entirely by operations in the variable length code domain. Accordingly, the transcoder need not perform quantisation/requantisation, forward/reverse Discrete Cosine Transformations, scanning etc as is normally associated with transcoders for data streams such as MPEG2 data streams.

Further aspects and details of the operation of the decoder of FIG. 1 will be described in the following. The description will specifically concentrate on transcoding of an MPEG 2 coded signal.

In the preferred embodiment, the subset processor 105 analyses the received data stream and divides out all data relating to the block, macroblock headers and motion vectors. These data should not be modified, and they are therefore fed to the encode processor for direct inclusion in the transcoded data stream.

The remaining data correspond to DCT coefficients that have been encoded using a variable length code and run length coding as is well known in the art. Specifically, the DCT coefficients are encoded according to tables B-14, B-15 and B-16 of the MPEG standard [ISO/IEC, International Standard 13818-2, Recommendation ITU-T H.262 Information Technology—Generic Coding of Moving Picture and Associated Audio Information: Video, 1995]. In accordance with this scheme, non-zero coefficients are represented by variable length coding of a value given as (R,L) wherein R is the run value of the coefficient, corresponding to the number of preceding zero value coefficients, and L is the level or value of the non-zero coefficient.

In the significance processor 107, the quantised DCT coefficients are divided into significant coefficients and less significant coefficients. The significance criterion used for this division preferably considers various characteristics of the individual coefficient including whether it has a value above a threshold, what the associated spatial DCT frequency of the coefficient is and what the run length for the coefficient is (such as the quantity of preceding zero coefficients).

Specifically, in the preferred embodiment, a coefficient is considered less significant if it satisfies the following condition:
R>Rt & n>Nt & L<Lt, (1)
where R is run value of the coefficient, n is the position of the coefficient in a one-dimensional matrix of a zig-zag scanned MPEG2 DCT block, L is the coefficient value known as the level of the coefficient and Rt, Nt and Lt are the corresponding threshold parameters for the truncation. The values of Rt, Nt and Lt may be changed in accordance with the parameters and requirements of the transcoder, and in particular in response to the desired transcoded bit rate.

The value Lt corresponds to a maximum threshold value of the value or level of a coefficient for it to be considered a less significant coefficient. Hence, all coefficient values higher than Lt are considered significant and thus will not be truncated. This minimises video degradation as all values comprising significant frequency components are considered significant.

The value Nt defines how many coefficients from the beginning of the scanned block should be considered significant coefficients and thus not be truncated. These first coefficients of the block are DC and low-frequency AC coefficients. They represent the most important information for the video quality and changing these may lead to significant visual distortion of the reconstructed image.

All coefficients that satisfy condition (1) are in the preferred embodiment truncated to zero. This results in loss of information and is thus a lossy operation. By truncating to a zero value, no variable length codeword is preferably produced for these coefficients. The value of Rt defines a minimal number of zeros, which should precede a less significant coefficient. Because the probability of zeros is higher in the high-frequency region of an MPEG2 DCT block (the low-right corner of the DCT block), this requirement allows for an efficient exploitation of the nature of a zig-zag scanning of the DCT block for suppression of high-frequency coefficients with low-value.

If the previous coefficient has been truncated to zero, and the current coefficient does not satisfy condition (1), the value (L) of the current coefficient remains unchanged, but its run length value (R) is updated according to (2):
Rᵢ′=Rᵢ₋₁+1+Rᵢ (2)
where Rᵢ′ is the new value of run parameter of current coefficient; Rᵢ₋₁ is the original value of run parameter of previous run-length coefficient, truncated to zero; and Rᵢ is the original value of the run parameter of the current run-length coefficient. Hence, the run length value of a significant coefficient is preferably modified to reflect increased zero coefficients resulting from truncation of less significant coefficients to a zero value.

If the previous coefficient has not been truncated and the current coefficient is significant (does not satisfy condition (1)), then the R and L values remain unchanged. The variable length code of such a current coefficient may be fed to the encode processor 109 for direct inclusion in the transcoded stream. In this way, only significant coefficients with a preceding less significant coefficient need to be variable length re-coded. The variable length codes of other significant coefficients may be copied without change. This provides for a low complexity transcoding providing a bit rate reduced transcoded data stream.

In the preferred embodiment, the transcoded bit rate is preferably further reduced by performing a diminution operation on the significant coefficients. Specifically, the value (and specifically the L-value) of the current coefficient is reduced by a shifting operation. Shifting may be considered a subtraction (reduction) by the some parameter S from the L values of coefficients within a DCT block.

An example of a variable length code used in MPEG2 is the following:

TABLE 1
Variable length code table of DCT coefficients
(derived from B-14 [5]).

| VL codeword | R | L | VL codeword | R | L |
|---|---|---|---|---|---|
| 011s | 1 | 1 | 0101s | 2 | 1 |
| 0001 10s | 1 | 2 | 0000 100s | 2 | 2 |
| 0010 0101s | 1 | 3 | 0000 0010 11s | 2 | 3 |
| 0000 0011 00s | 1 | 4 | 0000 0001 0100s | 2 | 4 |
| 0000 0001 1011s | 1 | 5 | 0000 0000 1010 0s | 2 | 5 |
| 0000 0000 1011 0s | 1 | 6 | ESCAPE code | 2 | 6 |

According to table 1, shifting of the L parameter from 3 to 1 for R=2 will reduce the variable length codeword by 6 bits. At the decoding side, the L value of the received coefficients should be shifted back from 1 to 3 by adding a shifting parameter to the received L value. Therefore, shifting does not introduce any extra loss of information.

Specifically, the shifting process preferably includes dropping (truncation) of coefficients with a value (level) lower than the given shifting parameter value. If S is a shifting value indicating the number of levels to switch a given L value, then a corresponding truncation level of Lt=S is effectively achieved. Therefore, the truncation operation of less significant coefficients may be implemented as part of the shifting operation corresponding to Lt=S and Rt=0 in condition (1).

The shifting parameter S, as well as thresholds Lt and Rt, may be dependent on the position of the coefficient within the DCT block and/or on the distribution of the values of the coefficients. Moreover, the shifting factor S may be determined adaptively for each pair (R, L). Specifically, S may be determined from a parameter Sb fixed for the whole DCT block multiplied by a coefficient position dependent shifting value. The position dependent shifting value may be comprised in a shift value matrix Sm.

The parameter Sb is preferably defined once per DCT block and depends on the maximum L-values within a block, the type of the block, the quantisation matrix etc. The matrix Sm provides different shifting values dependent on the position of the coefficient in the DCT block. The relative impact on the video quality of individual coefficients depends on the position of the coefficient within the 8×8 DCT block. Hence, the matrix Sm may reflect the individual importance of a coefficient and thus allow for individual shifting or truncation in response to the relative importance of a coefficient. As the corresponding spatial frequency increases towards the lower right hand corner, it allows for the shifting operation to depend on an associated frequency parameter of a signal encoded by the variable length coded stream.

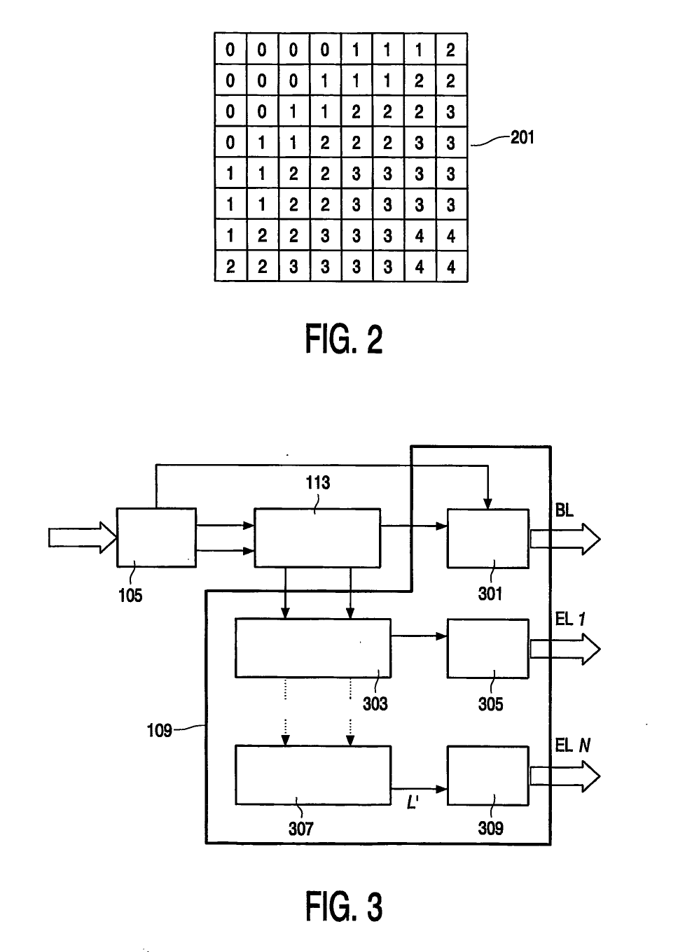

For different types of DCT blocks or related picture types, different shifting matrixes may be assigned. Generally, the values of elements of the matrix Sm are increasing in the direction from the upper left corner towards the lower right corner of the 8×8 DCT block, providing mainly reduction and truncation of the high-frequency coefficients. FIG. 2 is an illustration of an example of a shifting matrix 201. Specifically, the variable length codewords of pairs (R, L), for which the entry of Sm is zero, are copied from the incoming to the outgoing data stream without recoding.

In an embodiment where only truncation of less significant coefficients is used without shifting of significant coefficients, the matrix Sm may specifically define threshold levels for dropping (truncation) of insignificant coefficients (i.e. the Lt value of condition 1).

During shifting, the L values of all significant coefficients are changed. The R values should be updated according to (2) if the previous coefficient has been truncated. In order to speed up the process of transcoding, only coefficients with n>Nt may be shifted. The first n coefficients may be copied without change. Typically, the low-frequency coefficients have high L values and as seen in table 1, these tend to not lead to a significant reduction of the variable length code size. Hence, in some embodiments the truncation and/or diminution operation may be performed in response to an achievable word length reduction for at least one of the coefficients.

An example of a specific algorithm for transcoding of the DCT coefficients in variable length code domain using shifting is provided by the following pseudo code:

eob_not_read = 1;
n = 0;
while (eob_not_read)
{
< decode VL codeword to receive Ri, Li >
if (decoded VL codeword = eob.)

eob_not_read = 0;
else

{

n = n + Ri + 1;/* position of current coefficient */
Si = Sb * S[l, j]; /* definition of the shifting parameter */

if (n < Nt)
< copy VL codeword to outgoing stream >
else

if (Li < Si)

Tr = 1;

else
{
Li = Li − Si;
if (Tr =1)
Rᵢ = Rᵢ₋₁ + 1 + Rᵢ;
< VL coding of (Li; Ri) coefficient >;
Tr = 0;
}
}
}.

In some embodiments, the truncation part of this algorithm may be implemented separately. In this case, the above code should be changed by skipping the operation Li=Li−S.

In the preferred embodiment, both truncation of significant coefficients and shifting of less significant coefficients are performed. A suitable decoder furthermore comprises a receiver which receives the transcoded stream from the transcoder. In addition, it comprises a shift value receiver which receives information related to the value of shift value parameter used for shifting the coefficient values. The shift value parameter is fed to a shift processor that generates shift compensated data by performing an inverse shifting operation on the shifted coefficient values. The inverse shifting operation is performed according to the received shift value parameter. The resulting data stream is fed to a decode processor for decoding the underlying signal, and specifically the decode processor may perform a conventional MPEG2 decoding process.

In some embodiments, the encode processor 109 is operable to generate a scalable signal data stream comprising the transcoded data stream as a base layer and at least one additional enhancement layer. Hence, in one such embodiment, the transcoded data stream is implemented as a base layer and at least one enhancement layer is generated comprising some or all of the information lost during the truncation operation of the less significant coefficients.

FIG. 3 is an illustration of a transcoder for generating a scalable data stream in accordance with an embodiment of the invention. The trancoder corresponds to that of FIG. 1 with an encode processor 109 operable to generate a scalable signal.

The transcoder comprises a subset processor 105 connected to the encode processor 109 and truncation processor 111 as previously described. The encode processor 109 comprises a base layer encode processor 301 which generates the transcoded stream in accordance with the previous description. This transcoded stream is output as a base layer.

In the described embodiment, the truncation processor 111 does not discard any information lost in the truncation and/or diminution operations. Rather, this information is fed to a first enhancement layer processor 303 of the encode processor 109. Specifically, the remainder truncation and/or shifting values left over from the truncation processor 111 operation are fed to the first enhancement layer processor 303. The first enhancement layer processor 303 is connected to a first enhancement layer encode processor 305, and in one embodiment, the remainder coefficient values are simply encoded as a first enhancement layer by the first enhancement layer encode processor 305.

However, in the described embodiment, the first enhancement layer processor 303 performs a further truncation, and specifically a shifting, operation on the remainder coefficients. This further divides the remainder coefficients into more significant bits and less significant bits. The more significant bits are fed to the first enhancement layer encode processor 305, which combines these into a data stream, which is output as a first enhancement layer.

The least significant bits thus correspond to a second set of remainder values which are fed to a second enhancement layer processor 307. This second enhancement layer processor 307 feeds the second remainder coefficient values to a second enhancement layer encode processor 309, which generates a second enhancement layer therefrom.

Accordingly, the transcoder generates a base layer as a bit rate reduced data stream. This base layer comprises all necessary information for decoding the underlying signal albeit at a reduced quality level. Some or all of the information lost in the transcoding is provided in one or more further enhancement layers which may optionally be used to improve the decoded quality level.

In one scalable transcoder embodiment, the truncation and diminution of coefficients is performed by shifting of the value of the coefficient (the L value) by a given shift value. In this case the significant coefficients are automatically determined as the coefficients having a non-zero value following the shift.

In this embodiment, the levels which have been shifted out are fed to the next enhancement layer processor. This enhancement layer processor also performs a shifting operation. The coefficients having a non-zero value following the shift are encoded as the next enhancement layer. This process is repeated in consequent enhancement layer processors whereby a plurality of enhancement layers may easily be generated.

Hence, a coefficient is regarded as significant if its L value is bigger than the shifting parameter, and otherwise the coefficient is considered less significant. The value of the shifting parameter defines the number of enhancement layers and the size of the base layer. If the value of the shifting parameter is high enough to generate several enhancement layers, each layer will have different priority. The higher the L value of the less significant coefficients located within an enhancement layer, the higher the priority of this layer.

During shifting, the L values of all significant coefficients are changed. The new L′ values are determined by subtracting the shifting parameter from the original L value:
L′=L−S,
where S is the shifting parameter.

The R values of significant coefficients should be changed only in case the previous coefficient was insignificant and has been allocated in an enhancement layer.

In case of the current coefficient being less significant, it should be allocated in the enhancement layer. It is possible to generate several enhancement layers simultaneously. In order to define in which enhancement layer the less significant coefficient should be allocated, its L value is compared with decreasing values of the shifting parameter (in the enhancement layer processors). The R value of less significant coefficient is redefined according to the new locations and R values of the previous coefficients. In this way, each enhancement layer is encoded separately and in parallel. This may allow for a fast transcoding thus enabling high data rates and/or low delays.

The variable length decoder on the receiving side may decode layers either independently and in parallel, or may first reconstruct the complete stream in the variable length domain from the received layers before decoding one stream.

An example of a specific algorithm for transcoding of the DCT coefficients in variable length code domain with generation of layering enhance information is provided by the following pseudo code:

eob_not_read = 1;
n = 0;
i=0;
K0=K1=...Kn=0; /* number of previous coefficient in current layer */
while (eob_not_read)
{
<decode variable length codeword to receive Ri, Li>;
i=i+1 ; /* number of decoded variable length codeword */
if (decoded variable length codeword = eob.)

eob_not_read = 0;
else

{

n = n + Ri + 1; / * position of current coefficient in the incoming
scanned DCT block */

if (n < Nt)

{
<copy variable length codeword to the outgoing stream>
K0=i;

}

else

if(Li > S)

{

Li = Li − S;
${R}_{i} = {\sum }_{j = Ko + 1}^{i - 1} {R}_{j} + {R}_{i} ;$
K0 = i;
< variable length coding of (Li; Ri) coefficient in BL >;
}
else
{
h = 1 ;
v = 1 ;
while (h<S)
{
if (Li>=S − h)

{
${R}_{i} = {\sum }_{j = Kv + 1}^{i - 1} {R}_{j} + {R}_{i}$

Kv = i;
< variable lenght coding of (Li; Ri) coefficient in EL v>;
h=S;
}
else

{

h = h+1;
v = v+1;

}

}

}

}
}

In this algorithm, v is the number of enhancement layers, v=1 defines the enhancement layer with highest priority (next after the base layer). Kv is the number of the last coefficient coded in enhancement layer v. The process is carried out until code of “end of block” (e.o.b.) from the incoming stream is received.

Typically all R values of all coefficients within enhancement layers are modified as are some of the coefficients in base layer. The new R value of coefficient is defined as a sum of the original R values of the coefficients located in the incoming stream between the current coefficient and the last coefficient positioned in the current layer.

The shifting parameter S may be determined in response to a ratio of the bit-rate transcoding data rate reduction. The larger the difference between the bit-rates of the incoming and the transcoded stream, the higher the value of the shift parameter S. The S value may specifically be transmitted in the beginning of the base layer stream.

In one embodiment, an encoder comprises a signal encoder for generating a variable length coded data stream from a signal, and a transcoder as described above converting the data stream from the signal encoder into a scalable data stream.

A decoder may be implemented for a scalable data stream generated by the above process. In one embodiment, the decoder comprises a receiver for receiving the scalable content signal data stream. The receiver is connected to a combine processor which generates a combined data stream by combining the coefficients of the different layers. The combine processor is further connected to a decode processor which generates a decoded signal from the combined data stream.

The decoder may specifically perform a separate (and/or parallel) variable length decoding for each layer, and then from the decoded DCT coefficients of the different layers generate a single stream of complete DCT block coefficients.

Alternatively, a single stream may be decoded in the variable length domain. In this embodiment (R, L) pairs of coefficients are inserted from different layers into the correct positions within a single complete stream.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A transcoder for a variable length coded data stream comprising:
a receiver for receiving the variable length coded data stream comprising variable length coded coefficients;
a significance processor for determining if variable length coded coefficients are significant coefficients or less significant coefficients in accordance with a significance criterion;
a truncation processor for truncating the less significant coefficients;
an encode processor for generating a transcoded data stream comprising significant coefficients and truncated less significant coefficients.

2. A transcoder as claimed in claim 1 wherein the truncation comprises setting a value of the less significant coefficients to zero.

3. A transcoder as claimed in claim 1 wherein the significance criterion comprises a criterion of whether a value of a variable length coded coefficient is above a threshold.

4. A transcoder as claimed in claim 1 wherein the significance criterion is determined in response to an associated frequency parameter of a signal encoded by the variable length coded stream.

5. A transcoder as claimed in claim 1, wherein the variable length coded coefficients are run length coded and wherein the significance criterion comprises a criterion of whether a run length of a sequence of variable length coded coefficients is above a threshold.

6. A transcoder as claimed in claim 1, wherein the variable length coded coefficients are run length coded and wherein a run length value of a significant coefficient is modified to reflect increased zero coefficients resulting from truncation of less significant coefficients to a zero value.

7. A transcoder as claimed in claim 1 further comprising a subset processor for providing a subset of the variable length coded data stream to the encode processor; and wherein the encode processor is operable to directly include the subset of the variable length coded data stream in the transcoded data stream.

8. A transcoder as claimed in claim 7 wherein the subset of the variable length coded data stream comprises variable length coded coefficients associated with low frequency parameters of a signal coded by the variable length coded stream.

9. A transcoder as claimed in claim 7 wherein the subset of the variable length coded data stream comprises variable length coded coefficients associated with motion compensation parameters of a video signal coded by the variable length coded stream.

10. A transcoder as claimed in claim 7 wherein the subset of the variable length coded data stream comprises control data.

11. A transcoder as claimed in claim 7 wherein the subset of the variable length coded data stream comprises header data.

12. A transcoder as claimed in claim 1 wherein the truncation processor is further operable to perform a diminution operation on values of the significant coefficients.

13. A transcoder as claimed in claim 12 wherein the diminution operation is a shifting operation.

14. A transcoder as claimed in claim 12 wherein the diminution operation depends on an associated frequency parameter of a signal encoded by the variable length coded stream.

15. A transcoder as claimed in claim 12 wherein the diminution operation depends on a run length associated with at least one variable length coded coefficient.

16. A transcoder as claimed in claim 12 wherein a diminution operation parameter is depending on a plurality of coefficient values of the significant coefficients.

17. A transcoder as claimed in claim 12 wherein a diminution operation parameter depends on an achievable word length reduction for at least one of the significant coefficients.

18. A transcoder as claimed in claim 1 wherein the variable length coded coefficients comprise quantised Discrete Cosine Transform coefficients of a compressed video signal.

19. A transcoder as claimed in claim 1 wherein the encode processor is operable to generate a scalable signal data stream comprising the transcoded data stream as a base layer and at least one additional enhancement layer.

20. A transcoder as claimed in claim 19 wherein the truncation processor is operable to generate remainder coefficient values associated with the truncation of the less significant coefficients, and the at least one additional enhancement layer comprises at least some of the remainder coefficient values.

21. A transcoder as claimed in claim 19 wherein the truncation processor is operable to perform a shifting operation on the significant coefficients and to generate remainder coefficient values associated with the shifting operation; and the at least one additional enhancement layer comprises at least some of the remainder coefficient values.

22. A transcoder as claimed in claim 21 wherein the truncation processor is further operable to perform a second shifting operation on the remainder coefficient values and to generate second remainder coefficient values, and the encoding processor is operable to include at least some of the second remainder coefficient values in a second enhancement layer.

23. An encoder for encoding a signal comprising:
a signal encoder for generating a variable length coded data stream from the signal; the variable length coded data stream comprising variable length coded coefficients;
a significance processor for determining if variable length coded coefficients are significant coefficients or less significant coefficients in accordance with a significance criterion;
a truncation processor for truncating the less significant coefficients and for generating remainder coefficient values associated with the truncation of the less significant coefficients; and
an encode processor for generating a scalable signal data stream comprising a base layer comprising significant coefficients and truncated less significant coefficients and an enhancement layer comprising at least some of the remainder coefficient values.

24. A decoder for decoding a scalable content signal data stream; the decoder comprising:
a receiver for receiving the scalable content signal data stream; the scalable content signal data stream comprising a base layer comprising significant coefficients and truncated less significant coefficients, and an enhancement layer comprising remainder coefficient values associated with the truncated less significant coefficients;
a combine processor for generating a combined data stream from combining the variable length coded coefficients and truncated less significant coefficients of the base layer and the remainder coefficient values of the enhancement layer; and
a decode processor for generating a decoded signal in response to the combined data stream.

25. A decoder for decoding a variable length coded data stream; the decoder comprising:
a receiver for receiving a variable length coded data stream comprising variable length coded coefficients having shifted coefficient values; and
a shift processor for generating a shift compensated data stream by performing an inverse shifting operation on the variable length coded coefficients having shifted coefficient values; and
a decode processor for generating a decoded signal in response to the shift compensated data stream.

26. A decoder as claimed in claim 25 further comprising a shift value receiver for receiving a shift value parameter associated with the shifted coefficient values and wherein the inverse shifting operation is determined in response to the shift value parameter.

27. A method of transcoding of a variable length coded data stream, the method comprising the steps of:
receiving the variable length coded data stream comprising variable length coded coefficients;
determining if variable length coded coefficients are significant coefficients or less significant coefficients in accordance with a significance criterion;
truncating the less significant coefficients; and
generating a transcoded data stream comprising significant coefficients and truncated less significant coefficients.

28. A computer program product enabling the carrying out of a method according to claim 27.
